(19) United States
(12) Patent Application Publication
(10) Pub. No.: US 2024/0168452 A1
(43) Pub. Date: May 23, 2024

(54) PROCESS DIGITIZATION SYSTEM AND METHOD

(71) Applicant: BEET, Inc., Southfield, MI (US)

(72) Inventors: David Jingqiu Wang, Northville, MI (US); Aaron Gregory Romain, Dearborn, MI (US); Daniel Philip Romain, Northville, MI (US)

(73) Assignee: BEET, Inc., Southfield, MI (US)

(21) Appl. No.: 18/531,046

(22) Filed: Dec. 6, 2023

Related U.S. Application Data
(63) Continuation of application No. 16/957,604, filed on Jun. 24, 2020.
(60) Provisional application No. 62/621,623, filed on Jan. 25, 2018.
(60) Provisional application No. 62/621,709, filed on Jan. 25, 2018.

(51) Int. Cl. G05B 19/402; G05B 19/418; G06Q 10/087; G06Q 50/04

(52) U.S. Cl. CPC G05B 19/402; G05B 19/4185; G06Q 10/087; G06Q 50/04; G05B 2219/31266; G06K 7/10297

(57) ABSTRACT

In one embodiment, a method for a process facility is disclosed. The method includes identifying a plurality of moving entities and a plurality of movable parts associated with the process facility. The method further includes determining an action event for each of at least some interactions between one or more of the plurality of moving entities and one or more of the plurality of movable parts, where one or more of the at least some interactions include a manipulation of at least one of the plurality of movables parts by at least one of the plurality of moving entities. Moreover, the method includes determining an actual duration for each of at least some of the action events. Additionally, the method includes tracking the actual duration for each of at least some of the action events in relation to an expected duration of each action event.

### CROSS-REFERENCE TO RELATED APPLICATIONS

This application is a continuation of and claims the benefit of priority to U.S. patent application Ser. No. 16/957,604, filed Jun. 24, 2020, which claims the benefit of PCT application PCT/US2019/014930 filed on Jan. 24, 2019, which claims the benefit of U.S. Provisional Application 62/621,623 filed Jan. 25, 2018, and U.S. Provisional Application 62/621,709 filed Jan. 25, 2018, which are each hereby incorporated by reference in their entirety.

### TECHNICAL FIELD

The present disclosure relates to a system and method for tracking actions, including movement, of mobile assets which are used to perform a process within a facility.

### BACKGROUND

Material flow of component parts required to perform a process within a facility is one of the largest sources of down time in a manufacturing environment. Material flow of component parts is also one of the least digitized aspects of a process, as the dynamic nature of movement of component parts within a facility is complex and variable, requiring tracking of not only the direct productive parts such as workpieces and raw materials as these are moved and processed within the facility, but also requiring tracking of the carriers used to transport the workpieces and raw materials, which can include movement of the component parts by vehicles and/or human operators. Digitization of such an open-ended process with many component parts, carriers, and human interaction is very complex, and can be inherently abstract, for example, due to variability in the travel path of a component part through the facility, variety of carriers to transport the part, variability in human interaction in the movement process, etc. As such, it can be very difficult to collect data on material flow within a facility in a meaningful way. Without meaningful data collection, there is relatively minimal quantifiable analysis that can be done to identify sources of defects and delays and to identify opportunities for improvement in the movement and actioning of component parts within the facility, such that variation in movement of component parts within a facility is generally simply tolerated or compensated by adding additional and/or unnecessary lead time into the planned processing time of processes performed within the facility.

### SUMMARY

In one embodiment, a system in a process facility is disclosed. The system includes a processor and a memory in communication with the processor and having an algorithm. The algorithm has instructions that when executed by the processor, cause the processor to identify a plurality of moving entities and a plurality of movable parts associated with the process facility. The instructions further cause the processor to determine an action event for each of at least some interactions between one or more of the plurality of moving entities and one or more of the plurality of movable parts, where one or more of the at least some interactions include a manipulation of at least one of the plurality of movables parts by at least one of the plurality of moving entities. Moreover, the instructions cause the processor to determine an actual duration for each of at least some of the action events. Additionally, the instructions cause the processor to track the actual duration for each of at least some of the action events in relation to an expected duration of each action event.

In another embodiment, a method for a process facility is disclosed. The method includes identifying a plurality of moving entities and a plurality of movable parts associated with the process facility. The method further includes determining an action event for each of at least some interactions between one or more of the plurality of moving entities and one or more of the plurality of movable parts, where one or more of the at least some interactions include a manipulation of at least one of the plurality of movables parts by at least one of the plurality of moving entities. Moreover, the method includes determining an actual duration for each of at least some of the action events. Additionally, the method includes tracking the actual duration for each of at least some of the action events in relation to an expected duration of each action event.

### BRIEF DESCRIPTION OF THE DRAWINGS

FIG. 1 is a schematic perspective illustration of a facility including a system including a plurality of object trackers for tracking and analyzing actions of mobile assets used in performing a process within the facility;

FIG. 2 is a schematic top view of a portion of the facility and system of FIG. 1;

FIG. 3 is a schematic partial illustration of the system of FIG. 1 showing detection zones defined by the plurality of object trackers;

FIG. 4 is a schematic partial illustration of the system of FIG. 1 including a schematic illustration of an object tracker;

FIG. 5 is a perspective schematic view of an exemplary mobile asset configured as a part carrier and including at least one asset identifier;

FIG. 6 is a perspective schematic view of an exemplary mobile asset configured as a component part and including at least one asset identifier;

FIG. 7 is a schematic illustration of an example data flow and example data structure for the system of FIG. 1;

FIG. 8 is a schematic illustration of an example asset action list included in the data structure of FIG. 7;

FIG. 9 is a method of tracking and analyzing actions of mobile assets using the system of FIG. 1; and

FIG. 10 is an example visualization output of a heartbeat generated by the system of FIG. 1, for sequence of actions taken by a mobile asset.

### DETAILED DESCRIPTION

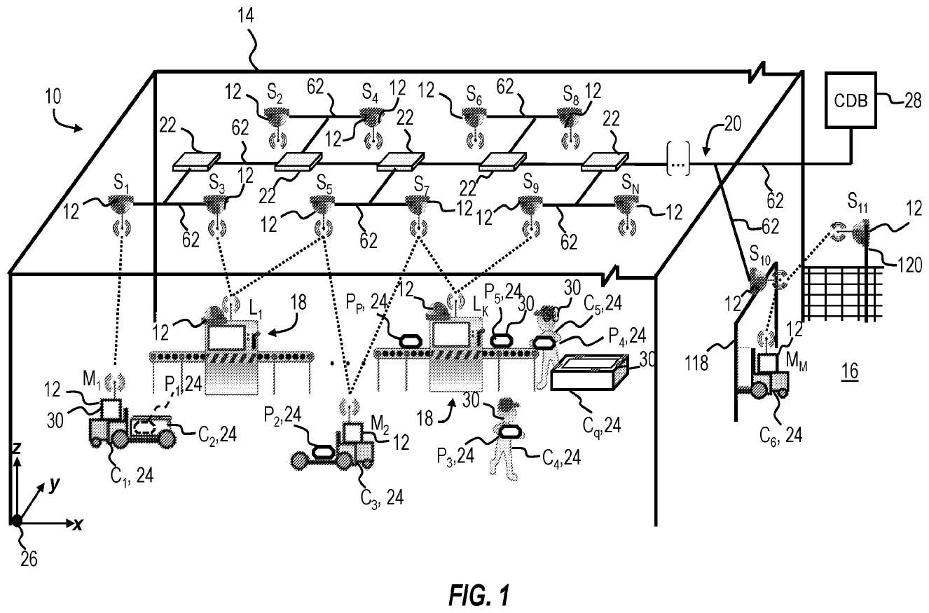

The elements of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein. Referring to the drawings wherein like reference numbers represent like components throughout the several figures, the elements shown in FIGS. 1-10 are not necessarily to scale or proportion. Accordingly, the particular dimensions and applications provided in the drawings presented herein are not to be considered limiting.

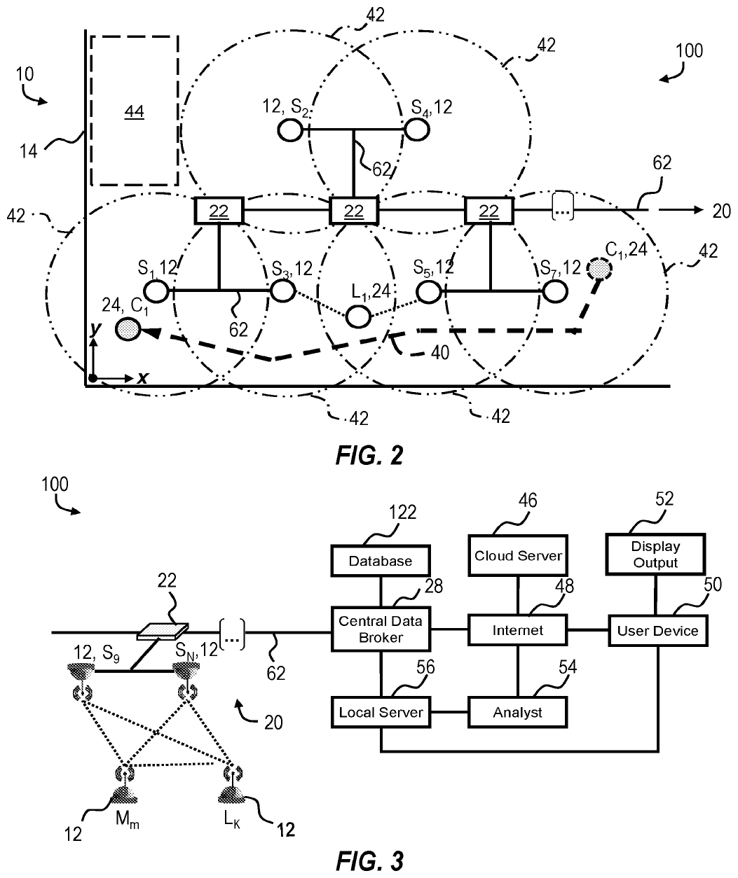

Referring to FIGS. 1-10, a system 100 and a method 200, as described in additional detail herein, are provided for tracking and analyzing actions of mobile assets 24 used to perform a process within a facility 10, utilizing a plurality of object trackers 12 positioned throughout the facility 10 to monitor, detect and digitize the actions of the mobile assets 24 within the facility 10, where the actions include movement of the mobile assets 24 within the facility 10. A mobile asset 24 can also be referred to herein as an asset 24. Each mobile asset 24 includes an identifier 30 and is assigned an asset identification (asset ID) 86 and an asset type 88. The asset ID 86 and asset type 88 for a mobile asset 24 are stored as an asset instance 104 associated with an asset description 84 of the mobile asset 24 in a database 122. In a non-limiting example, each mobile asset 24 includes and can be identified by an identifier 30 which is detectable by the object tracker 12 when the mobile asset 24 is located within a detection zone 42 defined by that object tracker 12 (see FIG. 2), such that an object tracker 12, upon detecting the mobile asset 24 in its detection zone 42 can track the movement and location of the detected mobile asset 24 in the detection zone 42 of that object tracker 12, in real time. The identifier 30 of a mobile asset 24 is associated with the asset instance 104, e.g., with the asset ID 86 and asset type 88, in the database 122, such that the object tracker 12, by identifying the identifier 30 of a detected mobile asset 24, can identify the asset ID 86 and the asset type 88 of the detected mobile asset 24. Each object tracker includes at least one sensor 64 for monitoring the detection zone 42 and detecting the presence of a mobile asset 24 and/or asset identifier 30 in the detection zone 42, where sensor input sensed by the sensor 64 is transmitted to a computer 60 within the object tracker 12 for time stamping with a detected time 92, and processing of the sensor input using one or more algorithms 70 to identify the detected identifier 30, to identify the detected mobile asset 24, including the asset ID 86 and asset type 88, associated with the identifier 30, to determine the location 96 of the asset 24 in the facility 10 at the detected time 92, and to determine one or more interactions 98 of the asset 24 at the detected time 92. Each object tracker 12 is in communication via a facility network 20 with a central data broker 28 such that the asset information detected by the object tracker 12, including the asset ID 86, asset type 88, detected time 92, detected action type 94, detected location 96 and detected interaction(s) 98 can be transmitted to the central data broker 28 as an action entry 90 for that detection event and stored to an action to an action list data structure 102 associated with the detected asset 24. The computer 60 within the object tracker 12 can be referred to herein as a tracker computer 60. The sensor input received from one or more sensors 64 included in the object tracker 12 can include, for example, sensed images, RFID signals, location input, etc., which is processed by the tracker computer 60 to generate the action entry 90 for each detected event. The action entry 90, in an illustrative example, is generated in JavaScript Object Notation (JSON), for example, by serializing the action entry data into a JSON string for transmission as an action entry 90 via the facility network 20 to the data broker 28. Advantageously, by digitizing the sensor input processed for each detection event into an action entry 90, using the tracker computer 60, it is not necessary to transmit the unprocessed sensor input over the facility network 20, and the amount of data required to be transmitted via the facility network 20 to the data broker 28 for each detection event is substantially reduced and simplified in structure.

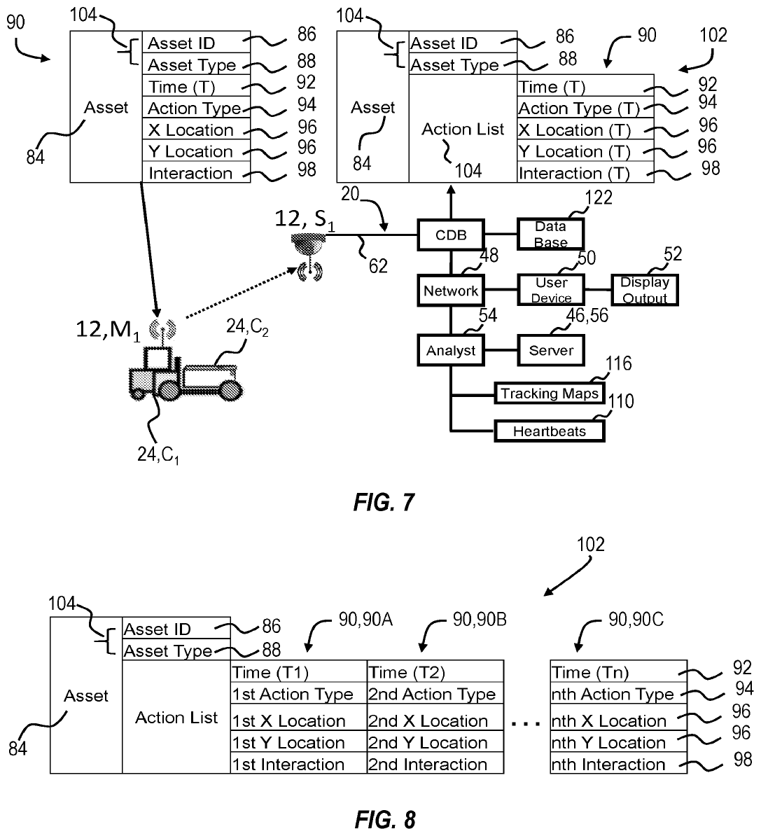

As the mobile asset 24 is moved through a sequence of actions 114 within the facility 10, the various object trackers 12 positioned within the facility 10 continue to detect the mobile asset 24, collect sensor input during each additional detection event, to process the sensor input to generate an additional action entry 90 for the detection event, and transmit the additional action entry 90 to the central data broker 28. The central data broker 28, upon receiving the additional action entry 90, deserializes the action entry data, which includes an asset ID 86 identifying the mobile asset 24, and maps the data retrieved from the additional action entry 90 to a data structure configured as an asset action list 102 associated with the mobile asset 24 identified in the action entry 90, as shown in FIG. 7. The asset action list 102, updated to include the data from the additional action entry 90, is stored to a database 122 in communication with the central data broker 28, as shown in FIGS. 3, 4 and 7. In a non-limiting example, the database 122 can be stored to one of the central data broker 28, a local server 56, or remote server 46.

In one example, the remote server 46 is configured as a cloud server accessible via a network 48 in communication with the remote server 46 and the central data broker 28. In one example, the network 48 is the Internet. The server 46, 56 can be configured to receive and store asset data and action data to the database 122, including for example, identifier 30 data, asset instance 104 data, action entry 90 data, and asset action list 102 data for each mobile asset 24, in a data structure as described herein. The server 46 can be configured to receive and store visualization outputs including, for example, tracking maps 116 and mobile asset heartbeats 110 generated by an analyst 54 in communication with the server 46, 56, using the action data.

The analyst 54 includes a central processing unit (CPU) 66 for executing one or more algorithms for analyzing the data stored in the database 122, and a memory, The analyst 54 can include, for example algorithms for analyzing the asset action lists 102, for determining asset event durations 108, for generating and analyzing visualization outputs including asset event heartbeats 110 and tracking maps 116, etc. The memory, at least some of which is tangible and non-transitory, may include, by way of example, ROM, RAM, EEPROM, etc., of a size and speed sufficient, for example, for executing the algorithms, storing a database, and/or communicating with the central data broker 28, the servers 46, 56, the network 48, one or more user devices 50 and/or one or more output displays 52.

The server 46, 56 includes one or more applications and a memory for receiving, storing, and/or providing the asset data, action data and data derived therefrom including visualization data, heartbeat data, map data, etc. within the system 100, and a central processing unit (CPU) for executing the applications. The memory, at least some of which is tangible and non-transitory, may include, by way of example, ROM, RAM, EEPROM, etc., of a size and speed sufficient, for example, for executing the applications, storing a database, which can be the database 122, and/or communicating with the central data broker 28, the analyst 54, the network 48, one or more user devices 50 and/or one or more output displays 52.

The analyst 54, also referred to herein as a data analyzer, is in communication with the server 46, 56, and analyzes the data stored to the asset action list 102, for example, to determine an actual duration 108 of each action and/or movement of the mobile asset 24, during processing within the facility 10, to identify a sequence 114 of action events 40 defined by the movements and/or actions, to map the location of the mobile asset 24 at the detected time 92 and/or over time to a facility map 116, to compare the actual action event duration 108 with a baseline action event duration, and/or to identify opportunities for improving asset movement efficiency and flow in the facility 10, including opportunities to reduce the action duration 108 of each movement and/or action to improve the effectiveness of the process by, for example, reduce processing time and/or increase throughput and productivity of the process. Advantageously, the system 100 and method 200 can use the data stored in the database 122 to generate visualization outputs, including, for example, a detailed map 116 of the facility 10, showing the tracked movement of the mobile assets 24 over time, and a heartbeat 110 for action events 40 of an asset 24, using the action durations 108 of sequential movements and actions of the asset 24 within the facility 10. The visualization outputs can be displayed, for example, via a user device 50 and/or an output display 52 in communication with the analyst 54.

Referring to FIGS. 1-8, an illustrative example of the system 100 for tracking and analyzing actions of mobile assets 24 used to perform a process within a facility 10 is shown. The facility 10 can include one or more structural enclosures 14 and/or one or more exterior structures 16. In one example, the performance of a process within the facility 10 can require movement of one or more mobile assets 24 within the structural enclosure 14, in the exterior structure 16, and/or between the structural enclosure 14 and the exterior structure 16. In the illustrative example shown in FIG. 1, the facility 10 is configured as a production facility including at least one structural enclosure 14 configured as a production building containing at least one processing line 18, and at least one exterior structure 16 configured as a storage lot including a fence 120. In the example, access for moving mobile assets 24 between the structural enclosure 14 and the exterior structure 16 is provided via a door 118. The example is non-limiting, and the facility 10 can include additional structural enclosures 14, such as additional production buildings and warehouses, and additional exterior structures 16.

The system 100 includes a plurality of object trackers 12 positioned throughout the facility 10 to monitor, detect and digitize the actions of one or more of the mobile assets 24 used in performing at least one process within the facility 10. Each object tracker 12 is characterized by a detection zone 42 (see FIG. 2), wherein the object tracker 12 is configured to monitor the detection zone 42 using one or more sensors 64 included in the object tracker 12, such that the object tracker 12 can sense and/or detect a mobile asset 24 when the mobile asset 24 is within the detection zone 42 of that object tracker 12. As shown in FIG. 2, an object tracker 12 can be positioned within the facility 10 such that the detection zone 42 of the object tracker 12 overlaps with a detection zone 42 of at least one other object tracker 12. Each of the object trackers 12 is in communication with a facility network 20, which can be, for example, a local area network (LAN). The object tracker 12 can be connected to the facility network 20 via a wired connection, for example, via an Ethernet cable 62, for communication with the facility network 20. In an illustrative example, the Ethernet cable 62 is a Power over Ethernet (POE) cable, and the object tracker 12 is powered by electricity transmitted via the PoE cable 62. The object tracker 12 can be in wireless communication with the facility network 20, for example, via WiFi or Bluetooth®.

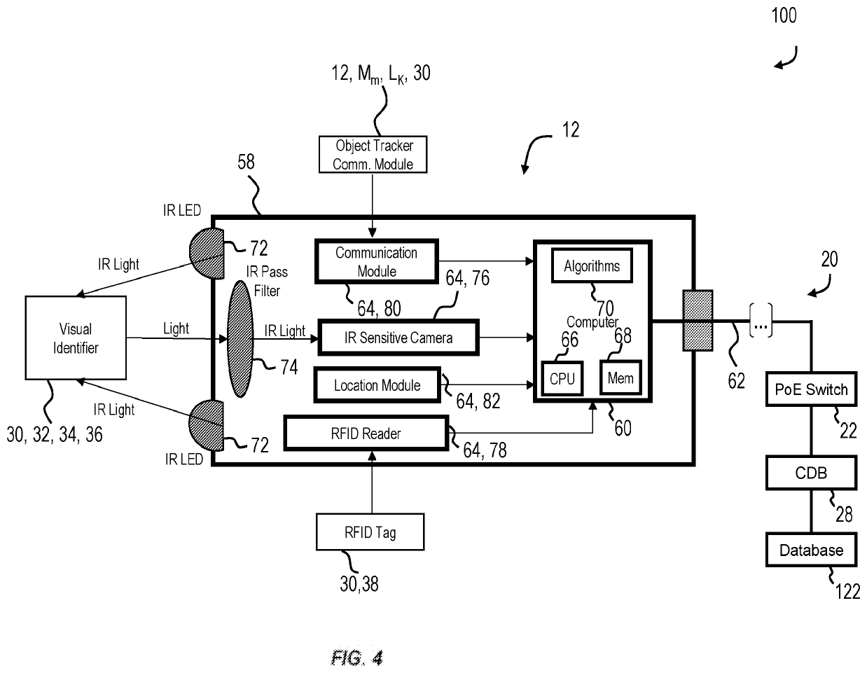

Referring again to FIG. 1, the plurality of object trackers 12 can include a combination of structural object trackers S₁ . . . S_{N}, line object trackers L₁ . . . L_{K}, and mobile object trackers M₁ . . . M_{M}, where each of these is can be configured substantially as shown in FIG. 4, however may be differentiated in some functions based on the type (S, L, M) of object tracker 12. Each of the object trackers 12 can be identified by a tracker ID, which in a non-limiting example can be an IP address of the object tracker 12. The IP address of the object tracker 12 can be stored in the database 122 and associated in the database 122 with one or more of a type (S, L, M) of object tracker 12, and a location of the object tracker 12 in the facility 10. In one example, the tracker ID can be transmitted with the data transmitted by an object tracker 12 to the central data broker 28, such that the central data broker can identify the object tracker 12 transmitting the data, and/or associate the transmitted data with that object tracker 12 and/or tracker ID in the database 122. The structural (S), line (L) and mobile (M) types of the object trackers 12 can be differentiated by the position of the object tracker 12 in the facility 10, whether the object tracker 12 is in a fixed position or is mobile, by the method by which the location of the object tracker is determined, and/or by the method by which the object tracker 12 transmits data to a facility network 20, as described in further detail herein. As used herein, a structural object tracker Sₓ refers generally to one of the structural object trackers S₁ . . . S_{N}, a line object tracker Lₓ refers generally to one of the line object trackers L₁ . . . L_{K}, and a mobile object tracker Mₓ refers generally to one of the mobile object trackers M₁ . . . M_{M}.

Each of the object trackers 12 includes a communication module 80 such that each structural object tracker Sₓ, each line object tracker Lₓ, and each mobile object tracker Mₓ can communicate wirelessly with each other object tracker 12, for example, using WiFi and/or Bluetooth®. Each of the object trackers 12 includes a connector for connecting via a PoE cable 62 such that each structural object tracker Sₓ, each line object tracker Lₓ, and each mobile object tracker Mₓ can, when connected to the facility network 20, communicate via the facility network 20 with each other object tracker 12 connected to the facility network 20. Referring to FIG. 1, the plurality of object trackers 12 in the illustrative example include a combination of structural object trackers S₁ . . . S_{N}, line object trackers L₁ . . . L_{K}, and mobile object trackers M₁ . . . M_{M}.

Each structural object tracker Sₓ is connected to one of the structural enclosure 14 or the exterior structure 16, such that each structural object tracker Sₓ is in a fixed position in a known location relative to the facility 10 when in operation. In a non-limiting example shown in FIG. 1, the location of each of the structural object trackers S₁ . . . S_{N} positioned in the facility 10 can be expressed as in terms of XYZ coordinates, relative to a set of X-Y-Z reference axes and reference point 26 defined for the facility 10. The example is non-limiting and other methods of defining the location of each of the structural object trackers S₁ . . . S_{N} positioned in the facility 10 can be used, including, for example, GPS coordinates, etc. The location of each of the structural object trackers S₁ . . . S_{N} can be associated with the tracked ID of the object tracker 12, and saved in the database 122. In the illustrative example, a plurality of structural object trackers Sₓ are positioned within the structural enclosure 14, distributed across and connected to the ceiling of the of the structural enclosure 14. The structural object trackers Sₓ can be connected by any means appropriate to retain each of the structural object trackers Sₓ in position and at the known location associated with that structural object trackers Sₓ. For example, a structural object tracker S can be attached to the ceiling, roof joists, etc., by direct attachment, by suspension from an attaching member such as a cable or bracket, and the like. In the example shown in FIGS. 1 and 2, the structural object trackers S are distributed in an X-Y plane across the ceiling of the structural enclosure 14 such that the detection zone 42 (see FIG. 2) of each one of the structural object trackers S₁ . . . S_{N} overlaps a detection zone 42 of at least one other of the structural object trackers S₁ . . . S_{N}, as shown in FIG. 2. The structural object trackers Sₓ are preferably distributed in the facility 10 such that each area where it is anticipated that a mobile asset 24 may be present is covered by a detection zone 42 of at least one of the structural object trackers Sₓ. For example, referring to FIG. 1, a structural object tracker Sₓ can be located on the structural enclosure 14 at the door 118, to monitor the movement of mobile assets 24 into and out of the structural enclosure 14. One or more structural object trackers Sₓ can be located in the exterior structure 16, for example, positioned on fences 122, gates, mounting poles, light posts, etc., as shown in FIG. 1, to monitor the movement of mobile assets in the exterior structure 16.

As shown in FIG. 2, the facility 10 can include one or more secondary areas 44 where it is not anticipated that a mobile asset 24 may be present, for example, an office area, and/or where installation of a structural object tracker Sₓ is infeasible. These secondary areas 44 can be monitored, for example and if necessary, using one or more mobile object trackers Mₓ. In the illustrative example, each structural object tracker Sₓ is connected to the facility network 20 via an PoE cable 62 such that the each structural object tracker Sₓ is powered via the PoE cable 62 and can communicate with the facility network 20 via the PoE cable 62. As shown in FIGS. 1 and 2, the facility network 20 can include one or more PoE switches 22 for connecting two or more of the object trackers 12 to the facility network 20.

Each line object tracker Lₓ is connected to one of processing lines 18, such that each line object tracker Lₓ is in a fixed position in a known location relative to the processing line 18 when in operation. In a non-limiting example shown in FIG. 1, the location of each line object tracker Lₓ positioned in the facility 10 can be expressed as in terms of XYZ coordinates, relative to a set of X-Y-Z reference axes and reference point 26 defined for the facility 10. The example is non-limiting and other methods of defining the location of each line object tracker Lₓ positioned in the facility 10 can be used, including, for example, GPS coordinates, etc. The location of each of the line object tracker Lₓ can be associated with the tracked ID of the object tracker 12, and saved in the database 122. In the illustrative example, one or more line object trackers Lₓ are positioned on each processing line 18 such that the detection zone(s) 42 of the one or more line object trackers Lₓ extend substantially over the processing line 18 to monitor and track the actions of mobile assets 24 used in performing the process performed by the processing line 18. Each line object tracker Lₓ can be connected by any means appropriate to retain the line object tracker Lₓ in a position relative to the process lining line 18 and at the known location associated with that line object tracker Lₓ in the database 122. For example, a line object tracker Lₓ can be attached to the processing line 18, by direct attachment, by an attaching member such as a bracket, and the like. In the illustrative example, each line object tracker Lₓ is connected to the facility network 20 via a PoE cable 62 where feasible, based on the configuration of the processing line 18, such that the line object tracker Lₓ can be powered via the POE cable 62 and can communicate with the facility network 20 via the PoE cable 62. Where connection of the line object tracker Lₓ via a PoE cable 62 is not feasible, the line object tracker Lₓ can communicate with the facility network 20, for example, via one of the structural object trackers Sₓ, by sending signals and/or data, including digitized action entry 90 data to the structural object tracker Sₓ via the communication modules 80 of the respective line object tracker Lₓ sending the data and the respective structural object tracker Sₓ receiving the data. The data received by the structural object tracker Sₓ from the line object tracker Lₓ can include, in one example, the tracker ID of the line object tracker Lₓ transmitting the data to the receiving structural object tracker Sₓ such that the structural object tracker Sₓ can transmit the tracker ID with the data received from the line object tracker Lₓ to the central data broker 28.

Each mobile object tracker Mₓ is connected to one of the mobile assets 24, such that each mobile object tracker Mₓ is mobile, and is moved through the facility 10 by the mobile asset 24 to which the mobile object tracker Mₓ is connected. Each mobile object tracker Mₓ defines a detection zone 42 which moves with movement of the mobile object tracker Mₓ in the facility 10. In a non-limiting example, the location of each mobile object tracker Mₓ in the facility 10 is determined by the mobile object tracker Mₓ at any time, using, for example, its location module 82 and a SLAM algorithm 70, where the mobile object tracker Mₓ can communicate with other object trackers 24 having a fixed location, to provide input for determining its own location. The example is non-limiting, and other methods can be used. For example, the location module 82 can be configured to determine the GPS coordinates of the mobile object tracker Mₓ to determine location. In the illustrative example, each mobile object tracker Mₓ communicates with the facility network 20, for example, via one of the structural object trackers Sₓ, by sending signals and/or data, including digitized action entry 90 data to the structural object tracker Sₓ via the communication modules 80 of the respective mobile object tracker Mₓ sending the data, and the respective structural object tracker Sₓ receiving the data. The data received by the structural object tracker Sₓ from the mobile object tracker Mₓ can include, in one example, the tracker ID of the mobile object tracker Mₓ transmitting the data to the receiving structural object tracker Sₓ such that the structural object tracker Sₓ can transmit the tracker ID with the data received from the mobile object tracker Mₓ to the central data broker 28. As the mobile object tracker Mₓ identifies mobile assets 24 detected in its detection zone 42, and generates asset entries 90 for each detected mobile asset 24, the mobile object tracker Mₓ transmits the generated asset entries 90 in real time to a structural object tracker Sₓ for retransmission to the central data broker 28 via the facility network 20, such that there is no latency or delay in the transmission of the generated asset entries 90 from the mobile object tracker Mₓ to the central data broker 28. By transmitting all data generated by all of the object trackers 12, including the mobile object trackers Mₓ to the central data broker 28 via a single outlet, the facility network 20, data security is controlled. Each mobile object tracker Mₓ can be powered, for example, by a power source provided by the mobile asset to which the mobile object tracker Mₓ is connected, and/or can be powered, for example, by a portable and/or rechargeable power source such as a battery.

In a non-limiting example, the mobile assets 24 being tracked and analyzed include part carriers C₁ . . . C_{q} and component parts P₁ . . . Pₚ, as shown in FIG. 1. In a non-limiting example, the actions of a mobile asset 24 which are detected and tracked by the object trackers 12 can include movement, e.g., motion, of the mobile asset, including transporting, lifting, and placing a mobile asset 24. In the illustrative example, the actions detected can include removing a component part Pₓ from a part carrier Cₓ, and/or moving a component part Pₓ to a part carrier Cₓ. As used herein, component part Pₓ refers generally to one of the component parts P₁ . . . Pₚ. A component part, as that term is used herein, refers to a component which is used to perform a process within a facility 10. In a non-limiting illustrative example, a component part Pₓ can be configured as one of a workpiece, an assembly including the workpiece, raw material used in forming the workpiece or assembly, a tool, gage, fixture, and/or other component which is used in the process performed within the facility 10. A component part is also referred to herein as a part.

As used herein, a part carrier Cₓ refers generally to one of the part carriers C₁ . . . C_{q}. A part carrier, as that term is used herein, refers to a carrier Cₓ which is used to move a component part Pₓ within the facility 10. In a non-limiting illustrative example, a part carrier Cₓ, can include any mobile asset 24 used to move or action a component part Pₓ, including, for example, containers, bins, pallets, trays, etc., which are configured to contain or support a component part Pₓ during movement or actioning of the component part Pₓ in the facility 10 (see for example carrier C₂ containing part P₁ in FIG. 1). A part carrier Cₓ can be a person 126, such as a machine operator or material handler (see for example carrier C₄ transporting part P₃ in FIG. 1). The part carrier Cₓ, during a detection event, can be empty or can contain at least one component part Pₓ. Referring to FIG. 1, a part carrier Cₓ can be configured as a mobile asset 24 used to transport another part carrier, including, for example, vehicles including lift trucks (see for example C₁, C₃ in FIG. 1), forklifts, pallet jacks, automatically guided vehicles (AGVs), carts, and people. The transported part carrier can be empty, or can contain at least one component part(s) Pₓ (see for example carrier C₁ transporting carrier C₂ containing part P₁ in FIG. 1). A part carrier is also referred to herein as a carrier.

Referring to FIG. 4, shown is a non-limiting example of an object tracker 12 including a tracker computer 60 and at least one sensor 64. The object tracker 12 is enclosed by a tracker enclosure 58, which in a non-limiting example, has an International Protection (IP) rating of IP67, such that the tracker enclosure 58 is resistant to solid particle and dust ingression, and resistant to liquid ingression including during immersion, providing protection from harsh environmental conditions and contaminants to the computer 60 and the sensors 64 encased therein. The tracker enclosure 58 can include an IP67 cable gland for receiving the Ethernet cable 62 into the tracker enclosure 58. The computer 60 is also referred to herein as a tracker computer. The at least one sensor 64 can include a camera 76 for monitoring the detection zone 42 of the object tracker 12, and for generating image data for images detected by the camera 76, including images of asset identifiers 30 detected by the camera 76. The sensors 64 in the object tracker 12 can include an RFID reader 78 for receiving an RFID signal from an asset identifier 30 including an RFID tag 38 detected within the detection zone 42. In one example, the RFID tag 38 is a passive RFID tag. The RFID reader 78 receives tag data from the RFID tag 38 which is inputted to the tracker computer for processing, including identification of the identifier 30 including the RFID tag 38, and identification of the mobile asset 24 associated with the identifier 30. The sensors 64 in the object tracker 12 can include a location module 82, and a communication module 80 for receiving wireless communications including WiFi and Bluetooth® signals, including signals and/or data transmitted wirelessly to the object tracker 12 from another object tracker 12. In one example, the location module 82 can be configured to determine the location of mobile asset 24 detected within the detection zone 42 of the object tracker 12, using sensor input. The location module 82 can be configured to determine the location of the object tracker 12, for example, when the object tracker 12 is configured as a mobile object tracker M_{X}, using one of the algorithms 70. In one example, the algorithm 70 used by the location module 82 can be a simultaneous localization and mapping (SLAM) algorithm, and can utilize signals sensed from other object trackers 12 including structural object trackers S₁ . . . S_{N} having known fixed locations, to determine the location of the mobile object tracker M_{X} at a point in time.

Referring again to FIGS. 1, 5 and 6, shown are non-limiting examples of various types and configurations of identifiers 30 which can be associated with a mobile asset 24 and identified by the object tracker 12 using sensor input received by the object tracker 12. Each mobile asset 24 includes and is identifiable by at least one asset identifier 30. While a mobile asset 24 is not required to include more than one asset identifier 30 to be detected by a objection tracker 12, it can be advantageous for a mobile asset 24 to include more than one identifier 30, such that, in the event of loss or damage to one identifier 30 included in the mobile asset 24, the mobile asset 24 can be detected and tracked using another identifier 30 included in the mobile asset 24.

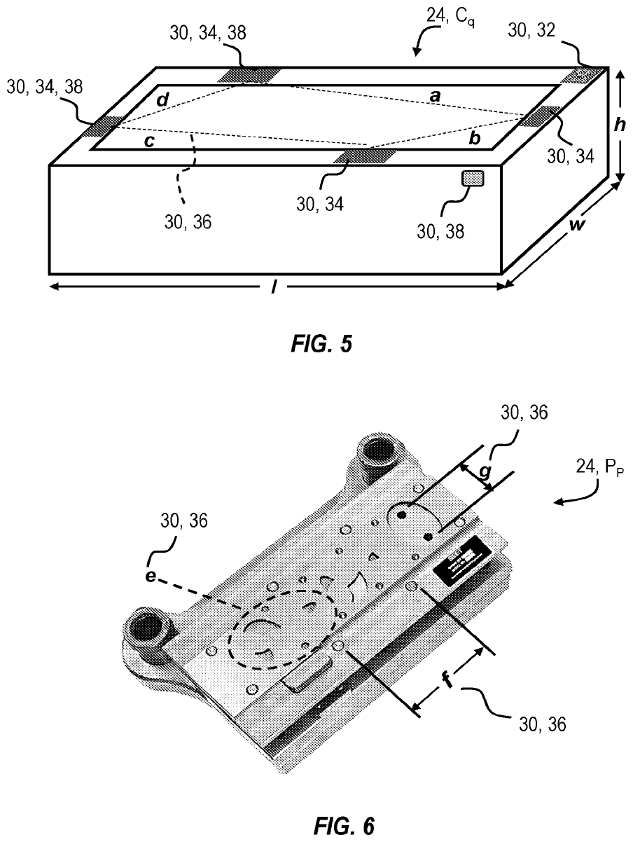

A mobile asset 24, which in the present example is configured as a carrier C_{q} for transporting one or more parts Pₓ is shown in FIG. 5 including, for illustrative purposes, a plurality of asset identifiers 30, including a QR code 32, a plurality of labels 34, a fiducial feature 36 defined by a pattern 136 (the polygon abcd) formed by the placement of the labels 34 on the carrier C_{q}, a fiducial feature defined by one or more identifying dimensions l, h, w, and an RFID tag 38. Each type 32, 34, 36, 38 of identifier 30 is detectable and identifiable by the object tracker 30 using sensor input received via at least one sensor 64 of the object tracker 30, which can be processed by the tracker computer 60 using one or more algorithms 70. Each identifier 30 included in a mobile asset 24 is configured to provide sensor input and/or identifier data which is unique to the mobile asset 24 to which it is included. The unique identifier 30 is associated with the mobile asset 24 which includes that unique identifier 30 in the database 122, for example, by mapping the identifier data of that unique identifier 30 to the asset instance 104 of the mobile asset 24 which includes that unique identifier 30. For example, the RFID tag 38 attached to the carrier C_{q}, which in a non-limiting example is a passive RFID tag, can be activated by the RFID reader 78 of the object tracker 12 and the unique RFID data from the RFID tag 38 read by the RFID reader 78 when the carrier C_{q} is in the detection zone 42 of the object tracker 12. The carrier C_{q} can then be identified by the tracker computer 60 using the RFID data transmitted from the RFID tag 38 and read by the RFID reader 78, which is inputted by the RFID reader 78 as a sensor input to the tracker computer 60, and processed by the tracker computer 60 using data stored in the database 122 to identify the mobile asset 24, e.g., the carrier C_{q} which is mapped to the RFID data.

In another example, the QR code 32 positioned on the carrier C_{q} can be detected using an image of the carrier C_{q} sensed by the camera 76 of the object reader 12 and inputted to the tracker computer 60 as a sensor input, such that the tracker computer 60, by processing the image sensor input, can detect the QR code data, which is mapped in the database 122 to the asset instance 104 of the carrier C_{q} and use the QR code data to identify the carrier C_{q}. In another example, the labels 34 can be detected using an image of the carrier C_{q} sensed by the camera 76 of the object reader 12 and inputted to the tracker computer 60 as a sensor input, such that the tracker computer 60, by processing the image sensor input, can each label. In one example, at least one of the labels 34 can include a marking, such as a serial number or bar code, uniquely identifying the carrier C_{q} and which is mapped in the database 122 to the asset instance 104 of the carrier C_{q} such that the tracker computer 60 in processing the image sensor input, can identify the marking and use the marking to identify the carrier C_{q}. In another example, the combination of the labels 34 can define a fiducial feature 36 shown in FIG. 5 as a pattern formed by the placement of the labels 34 on the carrier C_{q}, where, in the present example, the pattern defines a polygon abcd which is unique to the carrier C_{q}, and detectable by the tracker computer 60 during processing of the image sensor input. The identifier 30 defined by the fiducial feature 36, e.g., the unique polygon abcd, is mapped in the database 122 to the asset instance of the carrier C_{q}, such that the tracker computer 60 in processing the image sensor input, can identify and use the polygon abcd to identify the carrier C_{q}. In one example, the identifier 30 can be made of or include a reflective material, for example, to enhance the visibility and/or detectability of the identifier 30 in the image captured by the camera 76.

A mobile asset 24, which in the present example is configured as a part P_{P} is shown in FIG. 5 including, for illustrative purposes, a plurality of asset identifiers 30, including at least one fiducial feature 36 defined by at least one or a combination of part features e, f g, and a label 34. As described for FIG. 5, the label 34 can include a marking, such as a serial number or bar code, uniquely identifying the part P_{P} and which is mapped in the database 122 to the asset instance 104 of the part P_{P} such that the tracker computer 60 in processing the image sensor input, can identify the marking and use the marking to identify the part P_{P}. A fiducial feature 36 defined by at least one or a combination of part features e, f, g, can be formed by the combination of the dimension f and at least one of the hole pattern e and port hole spacing g the where combination of these is unique to the part P_{P} such that the tracker computer 60 in processing the image sensor input, can identify the marking and use the marking to identify the part P_{P}.

Referring to FIG. 1, a mobile asset 24 configured as a carrier C₁ is shown including a mobile object tracker M₁, where in the present example, the mobile object tracker M₁ is an identifier 30 for the carrier C₁, and the tracker ID of the mobile object tracker M₁ associated in the database 122 with the asset instance 104 of the carrier C₁ to which it is attached. When the carrier C₁ including the mobile object tracker M₁ enters a detection zone 42 of another object tracker 12 such as structural object tracker S₁ as shown in FIGS. 1 and 2, the structural object tracker S₁, via its communication module 80 can receive a wireless signal from the mobile object tracker M₁ which can be input from the communication module 80 of the structural object tracker S₁ to the tracker computer 60 of the structural object tracker S₁ as a sensor input, such that the tracker computer 60 in processing the sensor input, can identify the tracker ID of the mobile object tracker M₁ and to identify the mobile object tracker M₁ and the carrier C₁ to which the mobile object tracker M₁ is attached.

Referring again to FIG. 1, a mobile asset 24 identified in FIG. 1 as a carrier C₄ is a person, such as a production operator or material handler, shown in the present example transporting a part P₄. The carrier C₄ can include one or more identifiers 30 detectable by the object tracker 12 using sensor input collected by the object tracker 12 and inputted to the tracker computer 60 for processing, where the one or more identifiers 30 are mapped to the carrier C₄ in the database 122. In an illustrative example, the carrier C₄ can wear a piece of clothing, for example, a hat, which includes an identifier 30 such as a label 34 or QR code 32 which is unique to the carrier C₄. In an illustrative example, the carrier C₄ can wear an RFID tag 38, for example, which is attached to the clothing, a wristband, badge or other wearable item worn by the carrier C₄. In an illustrative example, the carrier C₄ can wear or carry an identifier 30 configured to output a wireless signal unique to the carrier C₄, for example, a mobile device such as a mobile phone, smart watch, wireless tracker, etc., which is detectable by the communication module 80 of the object tracker 12.

Referring again to the object tracker 12 shown in FIG. 4, the tracker computer 60 includes a memory 68 for receiving and storing sensor input received from the at least one sensor 64, and for storing and/or transmitting digitized data therefrom including action entry 90 data generated for each detection event. The tracker computer 60 includes a central processing unit (CPU) 66 for executing the algorithms 70, including algorithms for processing the sensor input received from the at least one sensor 64 to detect mobile assets 24 and asset indicators 30 sensed by the at least one sensor 64 within the detection zone 42 of the object tracker 12, and to process and/or digitize the sensor input to identify the detected asset identifier 30 and to generate data to populate an action entry 90 for the detected mobile asset 24 detected in the detection event using the algorithms 70. In a non-limiting example, the algorithms 70 can include algorithms for processing the sensor input, algorithms for time stamping the sensor input with a detection time 92, image processing algorithms including filtering algorithms for filtering image data to identify mobile assets 24 and/or asset identifiers 30 in sensed images, algorithms for detecting asset identifiers 30 from the sensor input, algorithms for identifying an asset ID 86 and asset type 88 associated with an asset identifier 30, algorithms for identifying the location of the detected mobile asset 24 using image data and/or other location input, and algorithms for digitizing and generating an action entry 90 for each detection event. The memory 68, at least some of which is tangible and non-transitory, may include, by way of example, ROM, RAM, EEPROM, etc., of a size and speed sufficient, for example, for executing the algorithms 70, storing the sensor input received by the object tracker 12, and communicating with local network 20 and/or with other object trackers 12. In one example, sensor input received by the tracker computer 60 is stored to the memory 68 only for a period of time sufficient for the tracker computer 60 to process the sensor input, that is, once the tracker computer 60 has processed the sensor input to obtain the digitized detection event data required to populate an action entry 90 for each mobile asset 24 detected from that sensor input, that sensor input is cleared from memory 68, thus reducing the amount of memory required by each object tracker 12.

As shown in FIG. 4, the object tracker 12 includes one or more cameras 76, one or more light emitting diodes (LEDs) 72, and an infrared (IR) pass filter 74, for monitoring and collecting image input from within the detection zone 42 of the object tracker 12. In a non-limiting example, the object tracker 12 includes a camera 76 which is an infrared (IR) sensitive camera, and the LEDs 72 are infrared LEDs, such that the camera 76 is configured to receive image input using visible light and infrared light. In a non-limiting example, the object tracker 12 can include an IR camera 76 configured as a thermal imaging camera, for sensing and collecting heat and/or radiation image input. It would be appreciated that the one or more cameras 76 included in the object tracker 12 can be configured such that the object tracker 12 can monitor its detection zone 42 for a broad spectrum of lighting conditions, including visible light, infrared light, thermal radiation, low light, or near blackout conditions. In a non-limiting example, the object tracker 12 includes a camera 76 which is a high resolution and/or high definition camera, for example, for capturing images of an identifier 30, such as fiducial features and dimensions of a component part P_{X}, identifying numbers and/or marks on a mobile asset 24 and/or identifier 30 including identifying numbers and/or marks on labels and tags, etc. As such, that the object tracker 12 is advantaged as capable of and effective for monitoring, detecting and tracking mobile assets 24 in all types of facility conditions, including, for example, low or minimal light conditions as can occur in automated operations, in warehouse or storage locations including exterior structures 16 which may be unlit or minimally lighted, etc. The camera 76 is in communication with the tracker computer 60 such that the camera 76 can transmit sensor input, e.g., image input, to the tracker computer 60 for processing by the tracker computer 60 using algorithms 70. In one example, the object tracker 12 can be configured such that the camera 76 continuously collects and transmits image input to the tracker computer 60 for processing. In one example, the object tracker 12 can be configured such that the camera 76 initiates image collection periodically, at a predetermined frequency controlled, for example, by the tracker computer 60. In one example, the collection frequency can be adjustable or variable based on operating conditions within the facility 10, such as shut down conditions, etc. In one example, the object tracker 12 can be configured such that the camera 76 initiates image collection only upon sensing a change in the monitored images detected by the camera 76 in the detection zone 42. In another example, the camera 76 can be configured and/or the image input can be filtered to detect images within a predetermined area of the detection zone 42. For example, where the detection zone 42 overlaps an area of the facility 42, such as an office area, where mobile assets 24 are not expected to be present, a filtering algorithm can be applied to remove image input received from the area of the detection zone 42 where mobile assets 24 are not expected to be present. Referring to FIG. 1, the camera 76 can be configured to optimize imaging data within a predetermined area of the detection zone 42, such as an area extending from the floor of the structural enclosure 14 to a vertical height corresponding to the maximum height at which a mobile asset 42 is expected to be present.

The tracker computer 60 receives sensor input from the various sensors 64 in the object tracker 12, which includes image input from the one or more cameras 76, and can include one or more of RFID tag data input from the RFID reader 78, location data input from the location module 82, and wireless data from the communication module 80. The sensor input is time stamped by the tracker computer 60, using a live time obtained from the facility network 20 or a live time obtained from the processor 66, where in the later example, the processor time has been synchronized with the live time of the facility network 20. The facility network 20 time can be established, for example, by the central data broker 28 or by a server such as local server 56 in communication with the facility network 20. Each of the processors 66 of the object trackers 12 is synchronized with the facility network 20 for accuracy in time stamping of the sensor input and accuracy in determining the detected time 92 of a detected mobile asset 24.

The sensor input is processed by the tracker computer 60, using one or more of the algorithms 70, to determine if the sensor input has detected any identifiers 30 of mobile assets 24 in the detection zone 42 of the object tracker 12, where detection of an identifier 30 in the detection zone 42 is a detection event. When one or more identifier 30 is detected, each identifier 30 is processed by the tracker computer 60 to identify the mobile asset 24 associated with the identifier 30, by determining the asset instance 104 mapped to the identifier 30 in the database 122, where the asset instance 104 of the mobile asset 24 associated with the identifier 30 includes the asset ID 86 and the asset type 88 of the identified mobile asset 24. The asset ID 86 is stored in the database 122 as a simple unique integer mapped to the mobile asset 24, such that the tracker computer 60, using the identifier 30 data, retrieves the asset ID 86 mapped to the detected mobile asset 24, for entry into an action entry 90 being populated by the tracker computer 60 for that detection event. A listing of types of assets is stored in the database 122, with each asset type 88 mapped to an integer in the database 122. The tracker computer 60 retrieves integer mapped to the asset type 88 associated with the asset ID in the database 122, for entry into the action entry 90. The database 122, in one example, can be stored in a server 46, 56 in communication with the central data broker 28 and the analyst 54, such that the stored data is accessible by the central data broker 28, by the analyst 54, and/or by the object tracker 12 via the central data broker 28. The server can include one or more of a local server 56 and a remote server 46 such as a cloud server accessible via a network 48. The example is non-limiting, and it would be appreciated that the database 122 could be stored in the central data broker 28, or in the analyst 54, for example. In an illustrative example, an asset type can be a category of asset, such as a part carrier or component part, can be a specific asset type, such as a bin, pallet, tray, fastener, assembly, etc., of a combination of these, for example, a carrier-bin, carrier-pallet, part-fastener, part-assembly, etc. Non-limiting examples of various types and configurations of identifiers 30 which may be associated with a mobile asset 24 are shown in FIGS. 5 and 6 and are described in additional detail herein.

The tracker computer 60 populates an action entry 90 data structure (see FIG. 7) for each detection event, entering the asset ID 86 and the asset type 88 determined from the identifier 30 of the mobile asset 24 detected during the detection event into the corresponding data fields in the action entry 90, and entering the timestamp of the sensor input as the detection time 92. The tracker computer 60 processes the sensor input to determine the remaining data elements in the action entry 90 data structure, including the action type 94. By way of example, action types 94 that can be tracked can include one or more of locating a mobile asset 24, identifying a mobile asset 24, tracking movement of a mobile asset 24 from one location to another location; lifting a mobile asset 24 such as lifting a carrier C_{X} or a part P_{X}, placing a mobile asset 24 such as placing a carrier C_{X} or a part P_{X} onto a production line 18; removing a mobile asset 24 from another mobile asset 24 such as unloading a carrier C_{X} (pallet, for example) from another carrier C_{X} (lift truck, for example) or removing a part P_{X} from a carrier C_{X}, placing a carrier C_{X} onto another carrier C_{X}, placing a part P_{X} to a carrier C_{X}, counting the parts P_{X} in a carrier C_{X}, etc., where the examples listed are illustrative and non-limiting. The tracker computer 60 processes the sensor input and determines the type of action being tracked from the sensor input, and populates the action entry 90 with the action type 94 being actioned by the detected asset 24 during the detection event. A listing of types of actions is stored in the database 122, with each action type 94 mapped to an integer in the database 122. The tracker computer 60 retrieves an integer which has been mapped to the action type 94 being actioned by the detected asset 24, for entry into the corresponding action type field in the action entry 90.

The tracker computer 60 processes the sensor input to determine the location 96 of the mobile asset 24 detected during the detection event, for entry into the corresponding field(s) in the action entry 90. In the illustrative example shown in FIG. 7, the data structure of the action entry 90 can include a first field for entry of an x-location and a second field for entry of a y-location, where the x- and y-locations can be x- and y-coordinates, for example, of the location of the detected mobile asset 24 in an X-Y plane as defined by the XYZ reference axes and reference point 26 defined for the facility 10. The tracker computer 60 can, in one example, use the location of the object tracker 12 at the time of the detection event, in combination with the sensor input, to determine the location 96 of the detected mobile asset 24. For a structural object tracker S_{X} and for a line object tracker L_{X}, the location of the object tracker 12 is known from the fixed position of the object tracker S_{X}, L_{X} in the facility 10. For an object tracker 12 configured as a mobile object tracker M_{X}, the tracker computer 60 and/or the location module 82 included in the mobile object tracker M_{X} can determine the location of the mobile object tracker M_{X} using, for example, a SLAM algorithm 70 and signals sensed from other object trackers 12 including structural object trackers S₁ . . . S_{N} having known fixed locations, to determine the location of the mobile object tracker M_{X} at the time of the detection event, which can then be used by the tracker computer 60 in combination with the sensor input to determine the location 96 of the detected mobile asset 24, for input into the corresponding location field(s) in the action entry 90. The example of entering an X-Location 96 and a Y-Location 96 into the action entry 90 is non-limiting, for example, other indicators of location could be entered into the action entry 90 such as GPS coordinates, a Z Location in addition to the X and Y locations, etc.

In one example, the sensor input can be used by the tracker computer 60 to determine one or more interactions 98 of the detected asset 24. The type and form of the data entry into the interaction field 98 of the action entry 90 is dependent on the type of interaction which is determined for the mobile asset 24 detected during the detection event. For example, where the detected asset 24 is a second part carrier C₂ being conveyed by another mobile asset 24 which is a first part carrier C₁, as shown in FIG. 1, an interaction 98 determined by the tracker computer 60 can be the asset ID 86 and the asset type 88 of the first part carrier C₁ being used to convey the detected asset 24, e.g., the second part carrier C₂. Using the same example shown in FIG. 1, the second part carrier C₂ is a container carrying a component part P₁, such that other interactions 98 which can be determined by the tracker computer 60 can include, for example, one or more of a quantification of the number, type, and/or condition of part P₁ being contained in the second part carrier C₂, where the part condition, in one example, can include a part parameter such as a dimension, feature, or other parameter (see FIG. 6) determinable by the object tracker 60 from the image sensor input. In one example, the part parameter can be compared by the object tracker 60 and/or the analyst 54, to a parameter specification, to determine whether the part condition conformance to the specification. The part parameter, for example, a dimension, can be stored as an interaction 98 associated, in the present example, with the part P₁, to provide a digitized record of the condition of the parameter. In the event of a nonconformance of the part condition to the specification, the system 100 can be configured to output an alert, for example, indicating the nonconformance of part P₁ canso that appropriate action (containment, correction, etc) can be taken. Advantageously, the detection of the nonconformance occurs in this example while the part P; is within the facility, such that the nonconforming part P₁ can be contained and/or corrected prior to subsequent processing and/or shipment from the facility 10. Subsequent tracking of the second part carrier C₂ and its interactions can include detection of unloading of the second part carrier C₁ from the first part carrier unloading of the component part P₁ from the second part carrier C 2, movement of the unloaded component part P₁ to another location in the facility 10, such as to a production line L₁, and so on, where each of these actions is detected by at least one of the object trackers 12, and generates, via the object tracker 12, an action entry 90 associated with at least one of the carriers C₁, C₂ and part P₁, each of which is a detected asset 24, and/or an interaction 98 between at least two more of the carriers C₁, C₂ and part P₁. In one example, the action entries 90 of the sequenced actions of the detected assets 24, including carriers C₁, C₂ and part P₁, and the action entries 90 transmitted to the central data broker 28 during detection of these assets, can analyzed by the analyst 54 using the detection time data T, location data 96 and interaction data 98 from the various action entries 90 and/or action list data structures 102 associated with each of the carriers C₁, C₂ and part P₁, to generate block chain traceability of the carriers C₁, C₂ and part P₁ based on their movements as detected by the various object trackers 12 during processing in the facility 10.

In one example, the tracker computer 60 can be instructed to enter a defined interaction 98 based on one or a combination of one of more of the asset ID 86, asset type 88, action type 94, and location 96. In an illustrative example, referring to FIGS. 1 and 6, when the line object tracker L_{K} detects part P_{P} (see FIG. 6) moving on an infeed conveyor processing by the processing line 18, the tracker computer 60 of the line object tracker L_{K} is instructed to process the image sensor input to inspect at least one parameter of the part P_{P}, for example, to measure dimension “g” shown in FIG. 6 and to determine whether the port hole pattern indicated at “e” shown in FIG. 6 conforms to a specified pattern, prompting the tracker computer 60 to enter into the interaction 98 field the inspection result, for example, the measurement of dimension “g” and a “Y” or “N” determination of conformance of the hole pattern of part P_{P} to the specified hole pattern. In one example, interaction 98 data entered into action entries 90 generated as the part P_{P} is processed by process lines 18 and/or moves through the facility 10, can provide block chain traceability of the part P_{P}, determined from the action list 102 data structure for the asset, in this example, part P_{P}. In a non-limiting example, the line object tracker L_{K} can be instructed, on finding the pattern to be non-conforming to the specified hole pattern, to output an alert, for example, to the processing line 18, to correct and/or to contain the nonconforming part P_{P} prior to further processing.

After the tracker computer 60 has populated the data fields 86, 88, 90, 92, 94, 96, 98 of the action entry 90 for the detected event, the action entry 90 is digitized by the tracker computer 60 and transmitted to the central data broker 28 via the facility network 20. In an illustrative example, the action entry 90 is generated in JavaScript Object Notation (JSON) by serializing the data populating the data fields 86, 88, 90, 92, 94, 96, 98 into a JSON string for transmission as an action entry 90 for the detected event. As shown in FIGS. 7 and 8, the central data broker 28 deserializes the action entry 90 data, and maps the action entry 90 data for the detected asset 24 to an action list 102 data structure for the detected asset 24, for example, using the asset instance 104, e.g., the asset ID 86 and asset type 88 of the detected asset 24. The data from the data fields 90, 92, 94, 96, 98 of the action entry 90 for the detected event is mapped to the corresponding data fields in the action list 102 as an action added to the listed action entries 90A, 90B, 90C . . . 90 n in the action list 102. The action list 102 is stored to the database 122 for analysis by the data analyst 54. The action list 102 can include an asset descriptor 84 for the asset 24 identified by the asset instance 104.

Over time, additional actions are detected by one or more of the object locators 12 as the asset 24 is used in performing a process within the facility 10, and additional action entries 90 are generated by the object locators 12 detecting the additional actions, and are added to the action list 102 of the mobile asset 24. For example, referring to FIG. 2, an action event 40 is shown wherein a mobile asset 24, shown in FIG. 2 as carrier C₁, is requested to retrieve a second mobile asset 24 shown in FIG. 1 as a pallet carrier C₂, and to transport the pallet carrier C₂ from a retrieval location indicated at C′₁, in FIG. 2, to a destination location indicated at C₁ in FIG. 2, where the delivery location corresponds to the location of the carrier C₁ shown in FIG. 1. The action event 40 of the carrier C₁ delivering the pallet carrier C₂ from the retrieval location to the destination location is illustrated by the path shown in FIG. 2 as a bold broken line indicated at 40. During execution of the action event 40, the carrier C₁ and the pallet carrier C₂ move through numerous detection zones 42, as shown in FIG. 2, including the detection zones defined by structural object trackers S₁, S₃, S₅, and S₇ and the detection zone defined by line object tracker S₁, S₃, S₅, and S₇ where each of these object trackers 12 generates and transmits one or more action entries 90 for each of the carriers C₁, C₂ to the central data broker 28 as the action event 40 is completed by the carrier C₁. In addition, during the action 40, the mobile object tracker M₁ attached to the carrier C₁ is generating and transmitting one or more action entries 90 for each of the carriers C₁, C₂. As previously described, the central data broker 28, upon receiving each of the action entries 90 generated by the various object trackers S₁, S₃, S₅, S₇, L₁ and M₁, deserializes the action entry data from each of the action entries and inputs the deserialized action entry data into the asset action list 102 corresponding to the action entry 90, and stores the asset action list 102 to the database 122.

Using the example of the asset action list 102 generated for the pallet carrier C₂, the data analyst 54 analyzes the asset action list 102, including the various action entries 90 generated for actions of the pallet carrier C₂ detected by the various object trackers 12 as the pallet carrier C₂ was transported by the carrier C₁ from the retrieval location to the destination location during the action event 40. The analysis of the asset action list 102 and the action entries 90 contained therein performed by the analyst 54 can include using one or more algorithms to, for example, reconcile the various action entries 90 generated by the various object trackers S₁, S₃, S₅, S₇, L₁ and M₁ during the action event 40, for example, to determine the actual path taken by the pallet carrier C₂ during the action event 40 using for example, the action type 94 data, the location 96 data and time stamp 92 data from the various action entries 90 in the asset action list 102, to determine an actual action event duration 108 for the action event 40 using, for example, the action event durations 108 and time stamp 92 data from the various action entries 90 in the asset action list 102, to generate a tracking map 116 showing the actual path of pallet carrier C₂ during the action event 40, to generate a heartbeat 110 of the mobile asset 24, in this example, pallet carrier C₂, to compare the actual action event 40 for example, to a baseline action event 40, to statistically quantify the action event 40, for example, to provide comparative statistical regarding the action event duration 108, etc. The analyst 54 can associate and store in the database 122 the action event 40 with asset instance 104 of the mobile asset 24, in this example the pallet carrier C₂, with the tracking map data (including path data identifying the path traveled by the pallet carrier C₂ during the action event 40), and with the action event duration 108 determined for the action event 40 and stored to the database 122. In an illustrative example, the action event 40 can be associated with one or more groups of action events having a common characteristic, for comparative analysis, where the common characteristic shared by the action events associated in the group like action, can be, for example, the event type, the action type, the mobile asset type, the interaction, etc.

The tracking map 116 and the mobile asset heartbeat 110 are non-limiting examples of a plurality of visualization outputs which can be generated by the analyst 54, which can be stored to the database 122 and displayed, for example, via a user device 50 or output display 52. In one example, the visualization outputs, including the tracking map 116 and mobile asset heartbeat 116 can be generated by the analyst 54 in near real time such that these visualization outputs can be used to provide alerts, show action event status, etc. to facilitate identification and implementation of corrective and/or improvement actions in real time. As used herein, an “action event” is distinguished from an “action”, in that an action event 40 includes, for example, the cumulative actions executed to complete the action event 40. In the present example, the action event 40 is the delivery of the pallet carrier C₂ from the retrieval location (shown at C′₁ in FIG. 2), to the destination location (indicated at C₁ in FIG. 2), where the action event 40 is a compilation of multiple actions detected by the object trackers S₁, S₃, S₅, S₇, L₁ and M₁ during completion of the action event 40, including, for example, each action of the pallet carrier C₂ detected by the object tracker S₁ in the detection zone 42 of the object tracker S₁ for which the object tracker S₁ generated an action entry 90, each action of the pallet carrier C₂ detected by the object tracker S₂ in the detection zone 42 of the object tracker S₂ for which the object tracker S₂ generated an action entry 90, and so on. As used herein, the term “baseline” as applied, for example, to an action event duration 108, can refer to one or more of a design intent duration for that action event 40, a statistically derived value, such as a mean or average duration for that action event 40 derived from data collected of like action events 40.

The tracking map 116 can include additional information, such as the actual time at which the pallet carrier C₂ is located at various points along the actual delivery path shown for the action event 40, the actual event duration 108 for the action event 40, etc., and can be color coded or otherwise indicate comparative information. For example, the tracking map 116 can display a baseline action event 40 with the actual event 40, to visual deviations of the actual action event 40 from the baseline event 40. For example, an action event 40 with an actual event duration 108 which is greater than a baseline event duration 108 for that action event can be coded red to indicate an alert or improvement opportunity. An action event 40 with an actual event duration 108 which is less than a baseline event duration 108 for that action event can be coded blue and investigate reasons for the demonstrated improvement, for replication in future action events of that type. The tracking map 116 can include icons identifying the action type 94 of the action event 40 shown on the tracking map 116, for example, whether the action event 40 is a transport, lifting, or placement type action. In one example, each action event 40 displayed on the tracking map 116 can be linked, for example, via a user interface element (UIE) to detail information for that action event 40 including, for example, the actual event duration 108, a baseline event duration, event interactions, a comparison of the actual event 40 to a baseline event, etc.

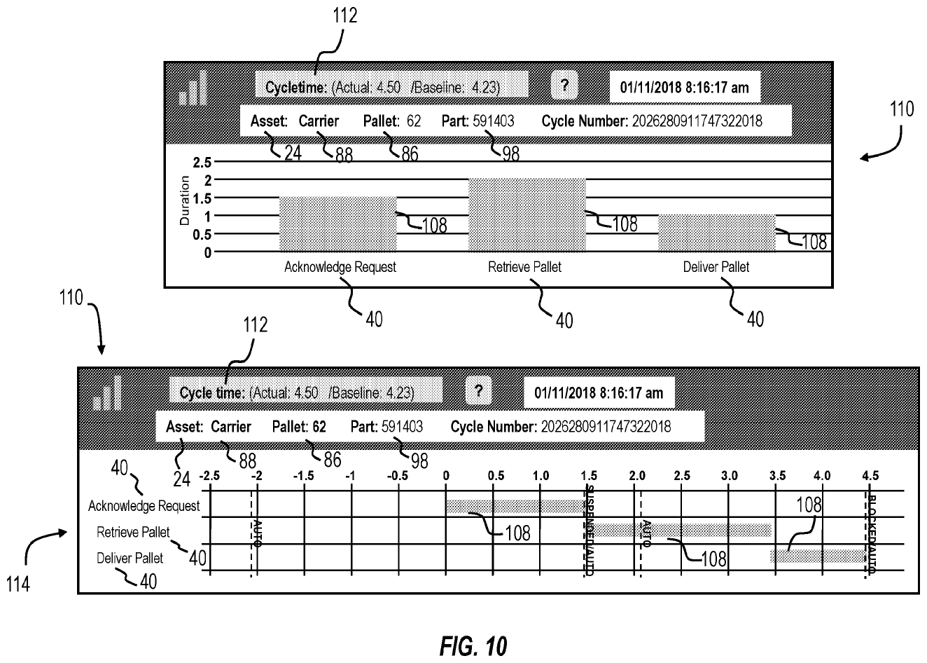

FIG. 10 illustrates an example of a heartbeat 110 generated by the analyst 54 for a sequence of action events 114 performed by a mobile asset 24, which in the present example is the pallet carrier C₂ identified in the heartbeat 110 as having an asset type 88 of “carrier”, and an asset ID of 62. The sequence of action events 114 include action events 40 shown as “Acknowledge Request”, “Retrieve Pallet,” and “Deliver Pallet”, where the action event 40 “Deliver Pallet” in the present example is the delivery of the pallet carrier C₂ from the retrieval location (shown at C′₁ in FIG. 2), to the destination location (indicated at C₁ in FIG. 2). The action event duration 108 is displayed for each of the action events 40. An interaction 98 for the sequence of action events 114 is displayed, where a part identification is shown, corresponding in the present example to the part P₁ transported in the pallet carrier C₂. A cycle time 112 is shown for the sequence of action events 114, including the actual cycle time 112 and a baseline cycle time. The heartbeat 110 is generated for the sequence of action events 114 as described in U.S. Pat. No. 8,880,442 B2 issued Nov. 4, 2014 entitled “Method for Generating a Machine Heartbeat”, by ordering the action event durations 108 of the action events 40 comprising the sequence of action events 114. The heartbeat 114 can be displayed as shown in the upper portion of FIG. 10, as a bar chart, or, as shown in the lower portion of FIG. 10, including the sequence of action events 114. Each of the displayed elements, for example, the action event durations 108, the cycle time 112, etc., can be color coded or otherwise visually differentiated to convey additional information for visualization analysis. In one example, each of the action event durations 108 may be colored “red”, “yellow”, “green”, or “blue” to indicate whether the action event duration 108 is, respectively, above an alert level duration, greater than a baseline duration, equal to or less than a baseline duration, or substantially less than a baseline duration indicating an improvement opportunity. In one example, one or more of the elements displayed by the heartbeat 110, including for example, the action event 40, the action event duration 108, the interaction 98, the sequence cycle time 112, the sequence of action events 114, can be linked, for example, via a user interface element (UIE) to detail information for that element. For example, the action event duration 108 can be linked to the tracking map 110, to show the action 40 corresponding to the action event duration 108.

In one example, the sequence of action events 114 can be comprised of action events 40 which are known action events 40, and can, for example, be included in a sequence of operations executed to perform a process within the facility 10, such that, by tracking and digitizing the actions of the mobile assets 24 in the facility 10, the total cycle time required to perform the sequence of operations of the process can be accurately quantified and analyzed for improvement opportunities, including reduction in the action event durations 108 of the action events 40. In one example, not all of the actions tracked by the object trackers 12 will be defined by a known action event 40. In this example, advantageously, the analyst 54 can analyze the action entry 90 data, for example, to identify patterns in actions of the mobile assets 12 within the facility 10, including patterns which define repetitively occurring action events 40, such that these can be analyzed, quantified, baselined, and systematically monitored for improvement.

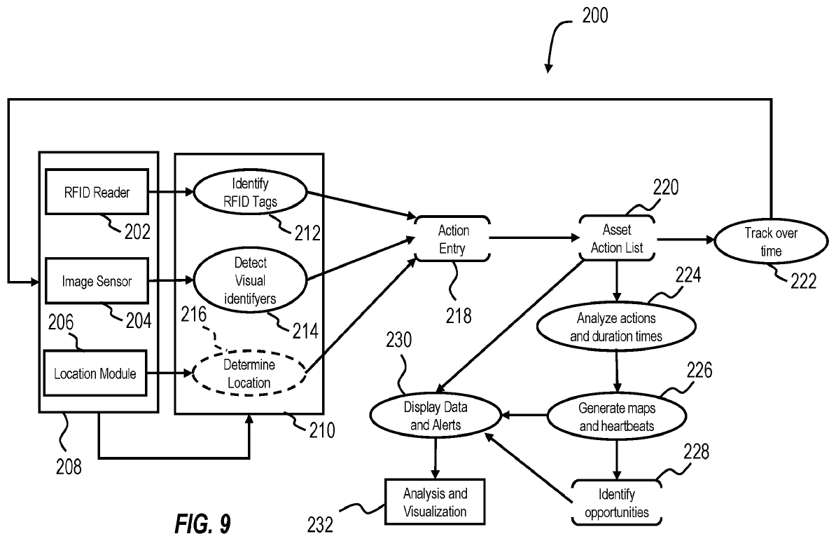

Referring now to FIG. 9, a method for tracking actions of the mobile assets 24 used to perform a process within the facility 10 is shown. The method includes, at 208, the object tracker 24 monitoring and collecting sensor input from within the detection zone 42 defined by the object tracker. The sensor input can include, as indicated at 202, RFID data received from an identifier 30 including an RFID tag 38, image sensor input, as indicated at 204, collected using a camera 72, which can be an IR sensitive camera, and location data, indicated at 206, collected using a location module 82. Location data can also be collected, for example, via a communication module 80, as described previously herein. At 210, the sensor input is received by the object tracker 12 and time stamped, as previously described herein, and the object tracker 12 processes the sensor input data, to at least one identifier 30 for each mobile asset 24 located within the detection zone 42, using, for example, one or more algorithms, to identify, at 212, an RFID identifier 38, at 214, a visual identifier 30 which can include one or more of a bar code identifier 32, a label identifier 34, and at 216, a fiducial identifier 36. At 218, the object tracker 12, using the identifier data determined at 210, populates an action entry 90 for each detection event found in the sensor input, digitizes the action entry 90, for example, into a JSON string, and transmits the digitized action entry 90 to a central data broker 28. At 220, the central data broker 28 deserializes the action entry 90, and maps the action entry 90 to an asset action list 102 corresponding to the detected asset 24 identified in the action entry 90, where the mapped action entry 90 data is entered into the asset action list 102 as an action entry 90, which can be one of a plurality of action entries 90 stored to that asset action list 102 for that detected mobile asset 24. Continuing at 220, the central data broker 28 stores the asset action list 102 to a database 122. At 222, the process of the object tracker 12 monitoring and collecting sensor input from its detection zone 42 continues, at shown in FIG. 9, to generate additional action entries 90 corresponding to additional identifiers 30 detected by the object tracker 12 in its detection zone 42. At 224, a data analyst 54 accesses the asset action list 102 in the database 122, and analyzes the asset action list 102 as described previously herein, including, at 224, determining and analyzing action event durations 108 for each action event 40 identified by the analyst 54 using the asset action list 102 data. At 226, the analyst 54 generates one or more visualization outputs such as tracking maps 116 and/or action event heartbeats 110. At 228, the analyst 54 identifies opportunities for corrective actions and/or improvements using the asset action list 102 data, which can include, at 230 and 232, displaying the data and alerts and displaying one or more visualization outputs such as the tracking maps 116 and/or action event heartbeats 110, output alerts, etc., generated at 226, for use in reviewing, interpreting, and analyzing the data to determine corrective actions and improvement opportunities, as previously described herein.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of ‘comprising’ and “including” to provide more specific embodiments and are also disclosed. As used in this disclosure and in the appended claims, the singular forms “a”, “an”, “the”, include plural referents unless the context clearly dictates otherwise.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A system in a process facility, comprising:
a processor; and
a memory in communication with the processor and having an algorithm, the algorithm having instructions that when executed by the processor, cause the processor to:
identify a plurality of moving entities and a plurality of movable parts associated with the process facility;
determine an action event for each of at least some interactions between one or more of the plurality of moving entities and one or more of the plurality of movable parts, wherein one or more of the at least some interactions include a manipulation of at least one of the plurality of movables parts by at least one of the plurality of moving entities;
determine an actual duration for each of at least some of the action events; and
track the actual duration for each of at least some of the action events in relation to an expected duration of each action event.

2. The system of claim 1, wherein the instructions further include instructions that when executed by the processor, cause the processor to:
determine that a difference between the actual durations of at least some of the action events and the expected durations of at least some of the action events exists; and
generate a visualization output indicative of the differences on a tracking map.

3. The system of claim 1, wherein the instructions to determine the action event include instructions to identify locations of the one or more of the plurality of moving entities and the one or more of the plurality of movable parts during the interactions between the one or more of the plurality of moving entities and the one or more of the plurality of movable parts.

4. The system of claim 1, wherein the instructions to determine the action event include instructions to track the at least some interactions while the one or more of the plurality of movable parts and the one or more of the plurality of moving entities are within the process facility.

5. The system of claim 1, wherein the instructions further include instructions that when executed by the processor, cause the processor to:
generate a display of the action event on a tracking map, wherein the display includes the actual durations, the expected durations, and the at least some interactions between the one or more of the plurality of moving entities and one or more of the plurality of movable parts.

6. The system of claim 1, wherein the action event includes at least one of:
a removal of at least one of the plurality of movable parts from at least one of the plurality of moving entities by another one of the at least one of the plurality of moving entities,
a placement of the at least one of the plurality of movable parts onto at least one of the plurality of moving entities by another one of the at least one of plurality of moving entities,
lifting at least one of the plurality of movable parts using at least one of the plurality of moving entities, or
placing at least one of the plurality of movable parts using at least one of the plurality of moving entities onto a production line.

7. The system of claim 1, wherein the action event includes controlling movement of at least one of the plurality of moving entities with another one of the plurality of moving entities.

8. The system of claim 1, wherein the at least some interactions between the one or more of the plurality of moving entities and the one or more of the plurality of movable parts occur when the one or more of the plurality of moving entities and the one or more of the plurality of movable parts are at least one of: on a production line and off of the production line.

9. The system of claim 8, wherein the at least some interactions include at least one of:
at least one of the one or more of the plurality of moving entities on the production line interacting with at least one of the one or more of the plurality of movable parts on the production line,
at least one of the one or more of the plurality of moving entities on the production line interacting with at least one of the one or more of the plurality of movable parts off of the production line,
at least one of the one or more of the plurality of moving entities off of the production line interacting with at least one of the one or more of the plurality of movable parts on the production line, or
at least one of the one or more of the plurality of moving entities off of the production line interacting with at least one of the one or more of the plurality of movable parts off of the production line.

10. The system of claim 1, wherein the instructions further include instructions that when executed by the processor, cause the processor to:
identify a sequence of action events based, at least in part, on a plurality of interactions between the one or more of the plurality of moving entities and the one or more of the plurality of movable parts.

11. A method for a process facility, comprising:
identifying a plurality of moving entities and a plurality of movable parts associated with the process facility;
determining an action event for each of at least some interactions between one or more of the plurality of moving entities and one or more of the plurality of movable parts, wherein one or more of the at least some interactions include a manipulation of at least one of the plurality of movables parts by at least one of the plurality of moving entities;
determining an actual duration for each of at least some of the action events; and
tracking the actual duration for each of at least some of the action events in relation to an expected duration of each action event.

12. The method of claim 11, further comprising:
determining that a difference between the actual duration of at least some of the action events and the expected duration of at least some of the action events exists; and
generating a visualization output indicative of the differences on a tracking map.

13. The method of claim 11, wherein the determining the action event includes identifying locations of the one or more of the plurality of moving entities and the one or more of the plurality of movable parts during the interactions between the one or more of the plurality of moving entities and the one or more of the plurality of movable parts.

14. The method of claim 11, further comprising:
generating a display of the action event on a tracking map, wherein the display includes the actual durations, the expected durations, and the at least some interactions between the one or more of the plurality of moving entities and one or more of the plurality of movable parts.

15. The system of claim 1, wherein determining the action event includes tracking the at least some interactions while the one or more of the plurality of movable parts and the one or more of the plurality of moving entities are within the process facility.

16. The method of claim 11, wherein the action event includes at least one of:
a removal of at least one of the plurality of movable parts from at least one of the plurality of moving entities by another one of the at least one of the plurality of moving entities,
a placement of at least one of the plurality of movable parts onto at least one of the plurality of moving entities by another one of the at least one of the plurality of moving entities,
lifting at least one of the plurality of movable parts using at least one of the plurality of moving entities, or
placing at least one of the plurality of movable parts using at least one of the plurality of moving entities onto a production line.

17. The method of claim 11, wherein the action event includes controlling movement of at least one of the plurality of moving entities with another one of the plurality of moving entities.

18. The method of claim 11, wherein the at least some interactions between the one or more of the plurality of moving entities and the one or more of the plurality of movable parts occur when the one or more of the plurality of moving entities and the one or more of the plurality of movable parts are at least one of: on a production line or off of the production line.

19. The method of claim 18, wherein the at least some interactions include at least one of:
at least one of the one or more of the plurality of moving entities on the production line interacting with at least one of the one or more of the plurality of movable parts on the production line,
at least one of the one or more of the plurality of moving entities on the production line interacting with at least one of the one or more of the plurality of movable parts off of the production line,
at least one of the one or more of the plurality of moving entities off of the production line interacting with at least one of the one or more of the plurality of movable parts on the production line, or
at least one of the one or more of the plurality of moving entities off of the production line interacting with at least one of the one or more of the plurality of movable parts off of the production line.

20. The method of claim 11, further comprising:
identifying a sequence of action events based, at least in part, on a plurality of interactions between the one or more of the plurality of moving entities and the one or more of the plurality of movable parts.
